(19) United States
(12) Patent Application Publication
(10) Pub. No.: US 2005/0215255 A1
(43) Pub. Date: Sep. 29, 2005

(54) Mobile communication system, base station and transmission power control method for use therein

(75) Inventor: Katsumi Tanoue, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/086,294

(22) Filed: Mar. 23, 2005

(30) Foreign Application Priority Data
Mar. 24, 2004 (JP) 85863/2004

(51) Int. Cl. H04Q 7/20

(52) U.S. Cl. 455/436; 455/522

(57) ABSTRACT

Here is provided a mobile communication system which uses a plurality of channels for communication. The plurality of channels comprise a first channel on which a mobile terminal communicates simultaneously with both a first base station and a second base station in a handover state wherein the mobile terminal is in an overlapping area of a cell of the first base station and a cell of the second base station, and a second channel on which the mobile terminal communicates with one of the first and second base stations even in the handover state.

The one of the first and second base stations comprises a handover state detector 22 for detecting information notified by a radio network controller regarding whether or not the mobile terminal is in the handover state, and also comprises a transmission power calculator 20 for calculating a value of downlink transmission power on the second channel on the basis of the information detected by the handover state detector 22.

### BACKGROUND OF THE INVENTION

1. Field of the Invention

The present invention relates to a mobile communication system, a radio base station and a transmission power control method for use therein, and more particularly to a transmission power control method for use in a high speed downlink packet access (HSDPA) communication system.

2. Description of the Related Art

In an HSDPA communication system which is discussed and standardized in 3GPP(3rd Generation Partnership Project), an HS-PDSCH (High Speed Physical Downlink Shared CHannel), an HS-SCCH [Shared Control CHannel for HS-DSCH (High Speed Downlink Shared CHannel)] and a DPCH (Dedicated Physical CHannel) are established between a mobile terminal and a radio base station. The HS-PDSCH is a communication channel shared by a plurality of users. The HS-SCCH is a control channel for notifying the mobile terminal number, coding rate, modulation system and so forth for each transmit timing. The DPCH is a physical channel established between each mobile terminal and a radio base station (see Japanese Patent Application Laid-Open No. 2002-369235).

Here, as the downlink-transmission power for the HS-SCCH, the sum of adding a certain offset to the instantaneous power of the downlink-DPCH between the pertinent mobile terminal and the radio base station is adopted. The value of this offset is set by an RNC (Radio Network Controller), which is a superior control device, for the radio base station on a call-by-call basis.

In a W-CDMA (Wideband-Code Division Multiple Access) system, when the mobile terminal is moving from the cell of one radio base station to that of another radio base station, a diversity handover for simultaneous communication with both base stations is applied to the DPCH.

Then, the downlink-transmission power on the DPCH from each cell is controlled by being raised or, lowered 1 dB on the basis of transmission power control bit information transmitted from each mobile terminal to the radio base station. The transmit power on the downlink-DPCH here is optimized with reference to the cell providing the optimal reception quality for the pertinent mobile terminal. The transmission power on the downlink-DPCH from other cells is set to be the same as this.

On the other hand, in an HSDPA communication system, the HS-PDSCH, which is the communication channel, and the HS-SCCH, which is the control channel, communicate with only a single cell even during a handover, without carrying out a diversity handover. For the DPCH, a diversity handover takes place with a plurality of cells. A control method for the downlink-transmission power of the HS-SCCH during a handover is stated in, for instance, Japanese Patent Application Laid-Open No. 2003-298508).

However, as stated above, the downlink-transmission power of the HS-SCCH, which is the control channel for HSDPA, is the sum of the addition of an offset to the transmission power of the downlink-DPCH. Further, the transmission power of the downlink-DPCH is determined with reference to the cell providing the optimal reception quality for the pertinent mobile terminal. Therefore, if the cell being engaged in HSDPA communication is not the cell for the optimal reception by the mobile terminal, the downlink-transmission power of the HS-SCCH cannot satisfy the quality requirement for the mobile terminal, and it may become impossible for the HSDPA communication to be performed normally.

### SUMMARY OF THE INVENTION

An object of the present invention is to eliminate the problems noted above and provide a mobile communication system, a radio base station and a transmission power control method for use therein which permit a mobile terminal in a handover state to keep the transmission power of the HS-SCCH at its optimum and can thereby contribute to improving the quality of HSDPA communication.

According to the invention, there is provided a mobile communication system which uses a plurality of channels for communication, the plurality of channels comprising: a first channel on which a mobile terminal communicates simultaneously with both a first base station and a second base station in a handover state wherein the mobile terminal is in an overlapping area of a cell of the first base station and a cell of the second base station; and a second channel on which the mobile terminal communicates with one of the first and second base stations even in the handover state, wherein the one of the first and second base stations comprises: a handover state detector for detecting information notified by a radio network controller regarding whether or not the mobile terminal is in the handover state; and a transmission power calculator for calculating a value of downlink transmission power on the second channel on the basis of the information detected by the handover state detector.

More specifically, the transmission power calculator may comprise: one or a plurality of memories for storing a plurality of different power offsets, and a selector for selecting one power offset out of the plurality of different power offsets stored in the one or plurality of memories on the basis of the information detected by the handover state detector.

In further specific terms, the transmission power calculator may comprise: a signal processor for supplying a value of transmission power on the first channel; a memory for storing a first power offset and a second power offset; a selector for selecting the first power offset if the handover state detector does not detect that the mobile terminal is in the handover state, and selecting the second power offset if the handover state detector detects that the mobile terminal is in the handover state; and an adder for adding a value of one of the first and second power offsets selected by the selector to the value of transmission power on the first channel supplied by the signal processor.

In another mobile communication system according to the invention, the one of the first and second base stations comprises: a best cell state detector for detecting information notified by a radio network controller regarding whether or not the cell of the one of the first and second base stations is in a best cell state; and a selector for selecting a power offset on the basis of the information detected by the best cell state detector for calculating a value of downlink transmission power on the second channel.

In still another mobile communication system according to the invention, the one of the first and second base stations comprises: a handover state detector for detecting information notified by a radio network controller regarding whether or not the mobile terminal is in a handover state; and a best cell state detector for detecting information notified by a radio network controller regarding whether or not the cell of the one of the first and second base stations is in a best cell state; and a transmission power calculator for calculating a value of downlink transmission power on the second channel on the basis of both the information detected by the handover state detector and the information detected by the best cell state detector.

A base station according to the invention uses a plurality of channels for communication, a first channel on which a mobile terminal communicates simultaneously with both the base station and a second base station in a handover state wherein the mobile terminal is in an overlapping area of a cell of the base station and a cell of the second base station; and a second channel on which the mobile terminal communicates with the base station even in the handover state, the base station comprising: a handover state detector for detecting information notified by a radio network controller regarding whether or not the mobile terminal is in the handover state; and a transmission power calculator for calculating a value of downlink transmission power on the second channel on the basis of the information detected by the handover state detector.

Another base station according to the invention comprises a best cell state detector for detecting information notified by a radio network controller regarding whether or not the cell of the station is in a best cell state; and a selector for selecting a power offset on the basis of the information detected by the best cell state detector for calculating a value of downlink transmission power on the second channel.

Still another base station according to the invention comprises a handover state detector for detecting information notified by a radio network controller regarding whether or not the mobile terminal is in a handover state; a best cell state detector for detecting information notified by a radio network controller regarding whether or not the cell of the base station is in a best cell state; and a transmission power calculator for calculating a value of downlink transmission power on the second channel on the basis of both the information detected by the handover state detector and the information detected by the best cell state detector.

A transmission power control method according to the invention for mobile communication systems uses a plurality of channels for communication, the plurality of channels comprising: a first channel on which a mobile terminal communicates simultaneously with both a first base station and a second base station in a handover state wherein the mobile terminal is in an overlapping area of a cell of the first base station and a cell of the second base station; and a second channel on which the mobile terminal communicates with one of the first and second base stations even in the handover state, the method comprising: at the one of the first and second base stations, detecting information notified by a radio network controller regarding whether or not the mobile terminal is in the handover state; and calculating a value of downlink transmission power on the second channel on the basis of the information.

More specifically, the transmission power control method for mobile communication systems may further comprise: at the one of the first and second base stations, selecting an offset value out of a plurality of different power offset values stored in the one of the first and second base stations on the basis of the information.

In further specific terms, the transmission power control method for mobile communication systems may further comprise: at the one of the first and second base stations, supplying a value of transmission power on the first channel; selecting a first power offset if the information indicates that the mobile terminal is not in the handover state; selecting a second power offset if the information indicates that the mobile terminal is in the handover state; and adding the selected first or second power offset to the value of transmission power on the first channel.

Another transmission power control method according to the invention for mobile communication systems comprises: at the one of the first and second base stations, detecting information notified by a radio network controller regarding whether or not the cell of the one of the first and second base stations is in a best cell state; selecting a power offset on the basis of the information; and calculating a downlink transmission power on the second channel on the basis of the power offset.

Still another transmission power control method according to the invention for mobile communication systems comprises: at the one of the first and second base stations, detecting first information notified by a radio network controller regarding whether or not the mobile terminal is in a handover state; detecting second information notified by a radio network controller regarding whether or not the one of the first and second base stations is in a best cell state; and calculating a value of downlink transmission power of the second channel on the basis of both the first and second information.

The mobile communication systems, base stations and transmission power control methods for mobile communication systems described above can be applied to an HSDPA (High Speed Downlink Packet Access) communication system; the first channel, to a DPCH (Dedicated Physical Channel); and the second channel, to an HS-SCCH [Shared Control CHannel for HS-DSCH (High Speed Downlink Shared CHannel)].

As the foregoing configurations make it possible to individually set power offset values to be added to the DPCH according to the presence or absence of a handover state or the presence or absence of the best cell state, the mobile terminal is enabled to keep the transmission power of the HS-SCCH optimal according to the prevailing one of these states, making it possible to improve the quality of HSDPA communication, more specifically to improve the throughput by reducing re-transmission and other undesirable factors.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 is, a block diagram showing the configuration of a mobile communication system, which is a preferred embodiment of the present invention;

FIG. 2 is a block diagram showing the configuration of an HS-SCCH transmission power determining unit of the radio base station in FIG. 1;

FIG. 3 is a sequence chart of the operation of the mobile communication system, which is the preferred embodiment of the invention;

FIG. 4 shows the contents of an Iub frame protocol;

FIG. 5 is a flow chart of the operation of the radio base station pertaining to the preferred embodiment of the invention;

FIG. 6 is a flow chart of the operation at S52 in FIG. 5 in more specific terms;

FIG. 7A shows the state of power control in a handover state and FIG. 7B, the state of power control in a non-handover state;

FIG. 8 is a sequence chart of the operation of a mobile communication system, which is another preferred embodiment of the invention;

FIG. 9 is a flow chart of the operation of a radio base station pertaining to the other preferred embodiment of the invention;

FIG. 10 is a flow chart of the operation at S92 in FIG. 9 in more specific terms;

FIG. 11 is a block diagram showing the configuration of another HS-SCCH transmission power determining unit in the radio base station of FIG. 1;

FIG. 12 is a flow chart of the operation of a radio base station pertaining to still another preferred embodiment of the invention; and

FIG. 13 is a flow chart of the operation at S123 in FIG. 12 in more specific terms.

### DETAILED DESCRIPTION OF THE PREFERRED EMBODIMENTS

Preferred embodiments of the present invention will be described below with reference to the accompanying drawings.

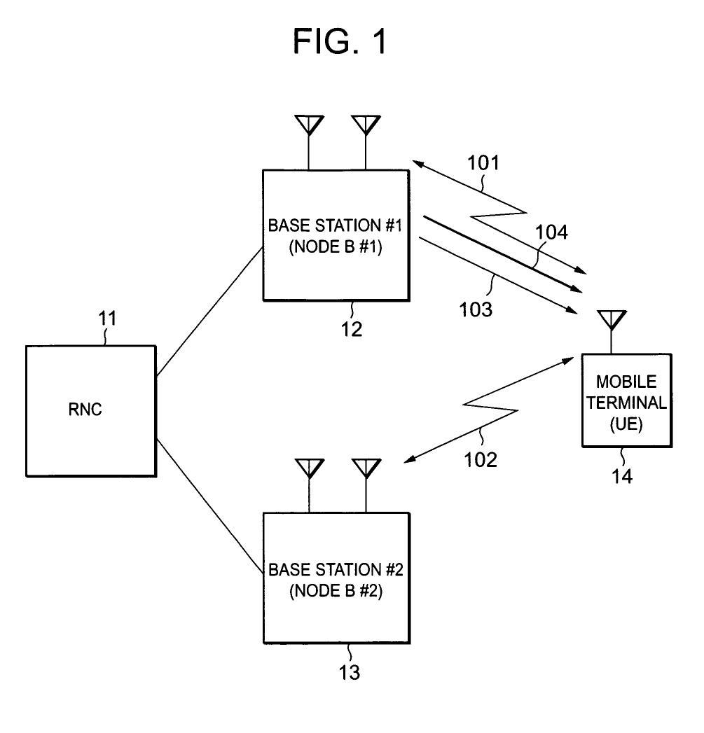

FIG. 1 is a block diagram showing the configuration of a mobile communication system, which is a preferred embodiment of the invention. More specifically, FIG. 1 shows a radio network for mobile communication to perform HSDPA (High Speed Downlink Packet Access) communication.

This mobile communication system comprises a radio network controller. (RNC) 11, a radio base station (hereinafter referred to as Node B) #1 12, a Node B #2 13 and a mobile terminal (hereinafter referred to as user equipment (UE)) 14 to perform HSDPA communication.

If the UE 14 performing HSDPA communication tries to transfer from the cell area of the Node B #1 12 to the cell area of the Node B #2 13, a handover takes place between the UE 14 and the radio network while the UE 14 is in an overlapping area of these two cells.

When this takes place, radio channels including a High Speed Physical Downlink Shared Channel (HS-PDSCH) 104, a Shared Control Channel for HS-DSCH (High Speed Downlink Shared Channel) (HS-SCCH) 103, a Dedicated Physical Channel (DPCH) 101 and 102 are established between the Node #1 12 and/or Node #2 13 and the UE 14.

The HS-PDSCH 104 here is a downlink-channel from the Node B #1 12 to the UE 14. The HS-SCCH 103 is also a downlink-channel from the Node B #1 12 to the UE 14. The DPCHs 101 and 102 are uplink- and downlink-channels between the Node B #1 12 and the Node B #2 13 and the UE 14.

During a handover, a diversity handover takes place only with respect to the DPCHs 101 and 102, but not to the HS-PDSCH 104 and the HS-SCCH 103.

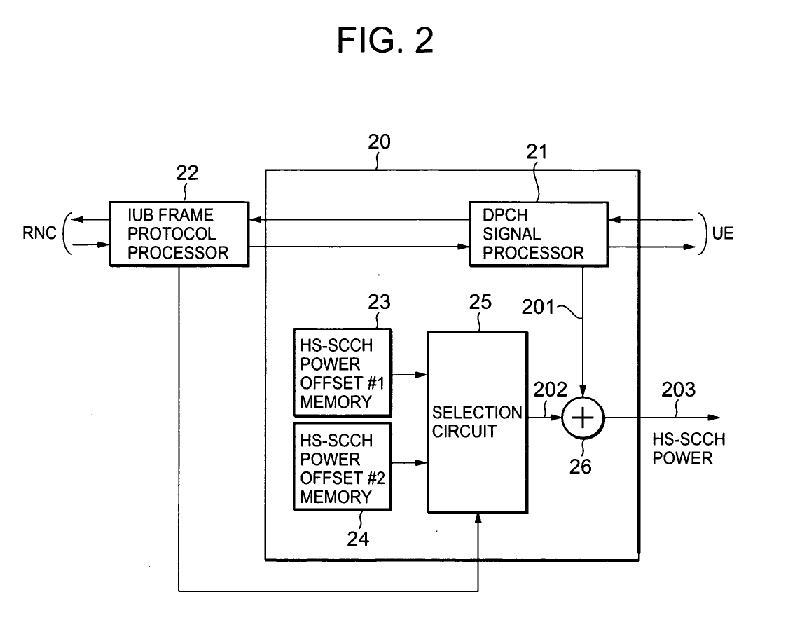

FIG. 2 is a block diagram showing the configuration of an HS-SCCH transmission power determining unit in each of the Node B #1 12 and the Node B #2 13 in FIG. 1. Referring to FIG. 2, the HS-SCCH transmission power determining unit has an Iub frame protocol processor 22 and an HS-SCCH transmission power calculator 20.

The Iub frame protocol processor 22 functions as a handover state detector for detecting information regarding whether or not the UE 14 is in a handover state. The Iub frame protocol processor 22 processes Iub frame protocols transmitted/received between the RNC 11 and the Node B #1 12 and Node B #2 13. If the Iub frame protocol processor 22 receives a handover state setting indication notified from the RNC 11, the Iub frame protocol processor 22 will indicate to a selection circuit 25 selection of an HS-SCCH power offset #2. If the Iub frame protocol processor 22 has received no handover state setting indication from the RNC 11 or has received a handover eliminating indication from the RNC 11, the Iub frame protocol processor 22 will indicate to the selection circuit 25 to select an HS-SCCH power offset #1.

The HS-SCCH transmission power calculator 20 has an HS-SCCH power offset #1 memory 23, an HS-SCCH power offset #2 memory 24, a DPCH signal processor 21, the selection circuit 25 and an adder 26.

The HS-SCCH power offset #1 memory 23 holds the HS-SCCH power offset #1, which is used when the UE 14 is not in a handover state. The HS-SCCH power offset #2 memory 24 holds the HS-SCCH power offset #2, which is used when the UE 14 is in a handover state. These two power offset values are set in advance for the Node B #1 12 and the Node B #2 13 in accordance with an indication from the RNC 11 or in some other maintenance procedure. Alternatively, the control device of the Node B #1 12 may determine an HS-SCCH power offset value according to the state of the electric wave or some other factor, and store it in the memory. Further, the control device of the Node B #1 12 may as well control the HS-SCCH power offset in a timely manner to be adaptable to its own station, and store it in the memory. Incidentally, the HS-SCCH power offset #1 memory 23 and the HS-SCCH power offset #2 memory 24 are not confined to this form, but the HS-SCCH power offsets #1 and #2 may as well be held in a physically single memory.

The DPCH signal processor 21 processes modulation, demodulation, coding and decoding of DPCH signals 101 established when HSDPA communication takes place between the UE 14 and the Node B #1 12 and Node B #2 13. The DPCH signal processor 21 notifies the adder 26 of DPCH downlink-transmission power information 201 for each slot.

The selection circuit 25 selects an HS-SCCH power offset value according to whether or not the UE 14 is in a handover state, and notifies the adder 26 of the selected HS-SCCH power offset information 202.

The adder 26 calculates the downlink-transmission power of the HS-SCCH by adding the DPCH downlink-transmission power notified by the DPCH signal processor 21 and the selected HS-SCCH power offset notified by the selection circuit 25.

The configuration described above, as the HS-SCCH transmission power is determined on the basis of whether the UE 14 is in a handover state or not, enables the HS-SCCH transmission power for the UE 14 to be maintained at an appropriate power. As a result, the quality of HSDPA communication can be improved.

Further, as the Node B #1 12 can hold an HS-SCCH power offset adapted to its own station, the HS-SCCH transmission power fitting the Node B #1 12 can be set appropriately and flexibly.

Moreover, information regarding the handover state can be detected at high speed because the Node B #1 12 performs reception from the RNC 11 by using the Iub protocol.

Next, the operation of the mobile communication system, which is this preferred embodiment of the invention will be explained.

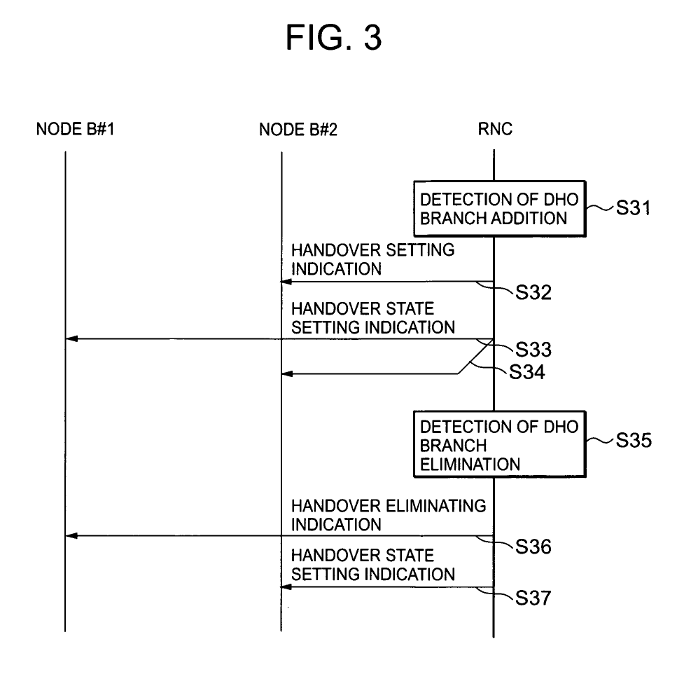

FIG. 3 is a sequence chart of the operation of the mobile communication system, which pertains to the embodiment of the invention. More specifically, FIG. 3 charts the operation of the RNC 11, the Node B #1 12 and the Node B #2 13 which take place when the UE 14 performing HSDPA communication carries out a handover. The UE 14 in this case is to shift from the cell area of the Node B #1 12 to the cell area of the Node B #2 13.

The RNC 11, receiving a handover request from the UE 14, decides to add a diversity handover (DHO) branch (S31). The decision is made with a processor (not shown) in the RNC 11. After that, it notifies the Node B #2 13, which manages the cell of the shift destination of the UE 14, of a handover setting indication (S32). The handover setting indication here is an indication to notify the base station of the forthcoming handover state and to request it for necessary setting. Further, the RNC 11 notifies the Node B #1 12, and the Node #2 13, which is its shift destination, of a handover state setting indication (S33 and S34). The handover state setting indication here is an indication to have the base station perceive whether or not the state is one of a handover. After that, communication is continued in a handover state.

On the other hand, the RNC 11, receiving a DHO branch elimination request from the UE 14, decides to eliminate a DHO branch (S35). The decision is made with a processor (not shown) in the RNC 11. After that, it notifies the radio Node B #1 12, of the handover eliminating indication (S36). The handover eliminating indication here is an indication to notify the base station of the end of the handover and to undo the setting necessary for the handover. The RNC 11 further notifies the Node B #2 13, which is the shift destination, of the handover state setting indication (S37). The Node B #2 is thereby enabled to understand the end of the handover state.

Next, the operation of the mobile communication system shown in FIG. 3 will be described in more specific terms.

When the UE 14 performing HSDPA communication shifts from the cell area of the Node B #1 12 to the cell area of the Node B #2 13, the RNC 11 having received a request to carry out a handover from the UE 14 decides on the addition of a diversity handover branch with a processor (S31).

The RNC 11 notifies the Node B. #2 13, which is the destination of the shift, of the handover setting indication (S32), and communication takes place in a diversity handover. In this process, the RNC 11 notifies by the Iub frame protocol each of the Node B #1 12 and the Node B #2 13 constituting the diversity handover branch of the handover state setting indication (S33 and S34).

Next, the Iub frame protocol used by the mobile communication system shown in FIG. 3 will be described in more specific terms.

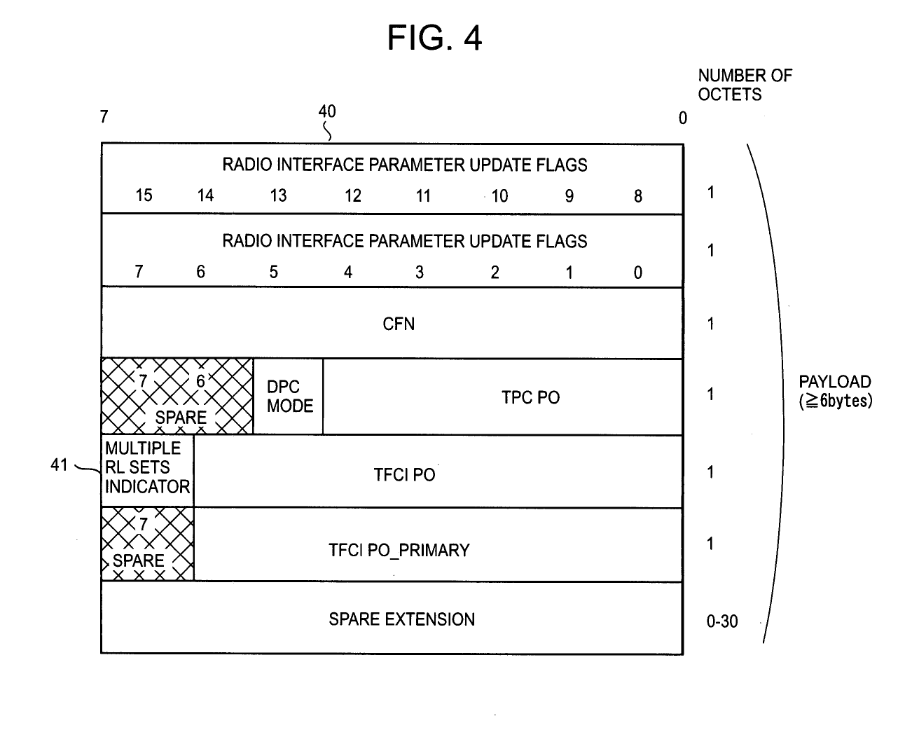

FIG. 4 shows the format 40 of the Iub frame protocol. A Multiple RL Sets Indicator 41 is an information bit indicating that the UE 14 is in the course of a handover. By this information bit, the RNC 11 informs the Node B #1 12 and the Node B #2 13 whether or not the UE 14 is in a handover state.

Next will be described the operation of the mobile communication system according to the invention, in particular the operation of the Node B #1 12.

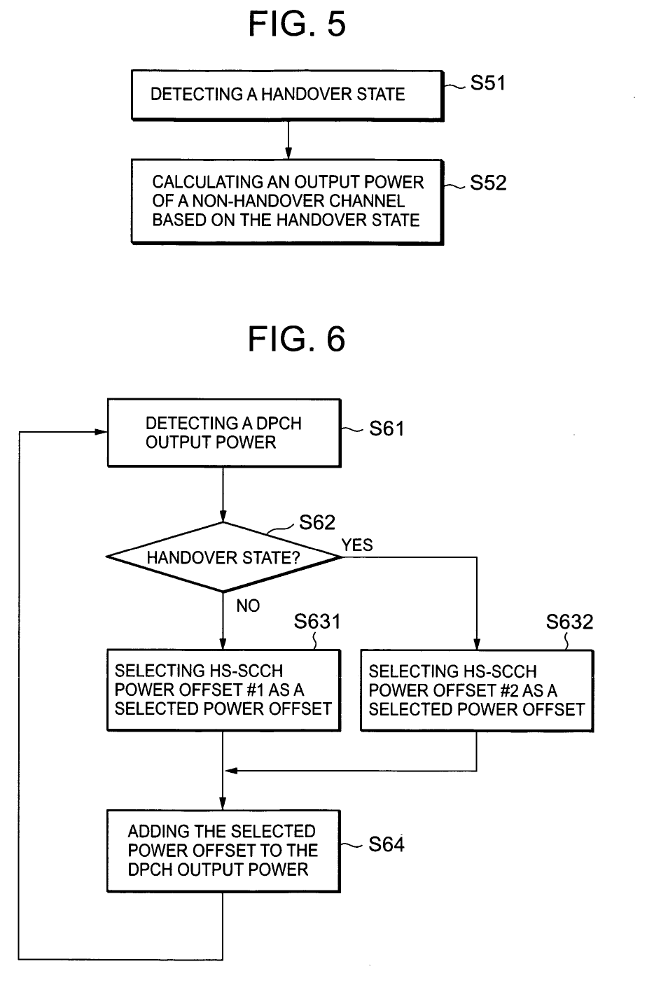

FIG. 5 is a flow chart for describing the operation of the Node B #1 12 to determine the transmission power of the HS-SCCH 103 in the mobile communication system performing HSDPA communication.

First, the Node B #1 12 detects a handover state (S51) At this step, the Node B #1 12 detects whether or not the UE 14 is in a handover state. This step can be accomplished by having the Iub frame protocol processor 22 of FIG. 2 process the information on the presence or absence of a handover state by which the RNC 11 notifies using Iub frame protocol 40. Its reception by the Node B #1 12 from the RNC 11 by using the Iub protocol makes possible high-speed detection of the information regarding the handover state.

Next, the Node B #1 12 calculates the transmission power of the non-handover channel on the basis of information regarding the detected handover state (S52). The non-handover channel means a channel on which diversity handover is not performed even when the UE 14 is in the overlapping area of the two cells, and here it is the HS-SCCH 103. This step can be accomplished by, for instance, the HS-SCCH transmission power calculator 20 shown in FIG. 2. This operation will be described afterwards.

The operation so far described provides the following benefits. Thus, since the HS-SCCH transmission power is determined on the basis of whether or not the UE 14 is in a handover state, it is possible to keep the HS-SCCH transmission power at an appropriate level for the UE 14 according to whether or not it is in a handover state. As a result, the quality of the HSDPA communication can be improved.

Next, the operation at S52 in FIG. 5 will be described more specifically.

FIG. 6 is a flow chart for describing the operation at S52 in FIG. 5 in more specific terms.

First, the Node B #1 12 recognizes the DPCH downlink-transmission power (S61). The recognition of the DPCH downlink-transmission power can be accomplished by the DPCH signal processor 21 shown in FIG. 2. The DPCH signal processor 21 notifies the adder 26 of the DPCH downlink-transmission power information 201.

The Iub frame protocol processor 22, on the basis of the invention detected at S51 in FIG. 5 regarding whether or not the process is in a handover state, instruct the selection circuit 25 to select either the HS-SCCH power offset #1 or #2 (S62). The HS-SCCH power offsets #1 and #2 are set in advance by the RNC 11 or some other maintenance means with respect to the Node B #1 12, and stored in the HS-SCCH power offset #1 memory 23 and the HS-SCCH power offset #2 memory 24, respectively. Or the control device of the Node B #1 12 may determine an HS-SCCH power offset value according to the state of the electric wave or some other factor, and store it in the memory. Further, the control device of the Node B #1 12 may as well control the HS-SCCH power offset in a timely manner to be adaptable to its own station, and store it in the memory. It is more preferable for the HS-SCCH power offset #2 to be greater than the HS-SCCH power offset #1. In this case, it is intended to improve the quality of communication by increasing the transmission power in the handover state..

If a non-handover state is detected, the Iub frame protocol processor 22 instructs the selection circuit 25 to select the HS-SCCH power offset #1. In response, the selection circuit 25 selects the HS-SCCH power offset #1 (S631).

If a handover state is detected, the Iub frame protocol processor 22 instructs the selection circuit 25 to select the HS-SCCH power offset #2. In response, the selection circuit 25 selects the HS-SCCH power offset #2 (S632).

The selection circuit 25 notifies the adder 26 of either the HS-SCCH power offset #1 or the HS-SCCH power offset #2 selected at S631 or S632, respectively, as the selected value of HS-SCCH power offset 202.

The adder 26 adds the selected value of HS-SCCH power offset 202 notified by the selection circuit 25 to the value of DPCH downlink-transmission power 201 notified by the DPCH signal processor 21 (S64).

The HS-SCCH transmission power calculated in this way is notified to an HS-SCCH transmission power control device (not shown). The operation described above is repeated for each slot of the HS-SCCH.

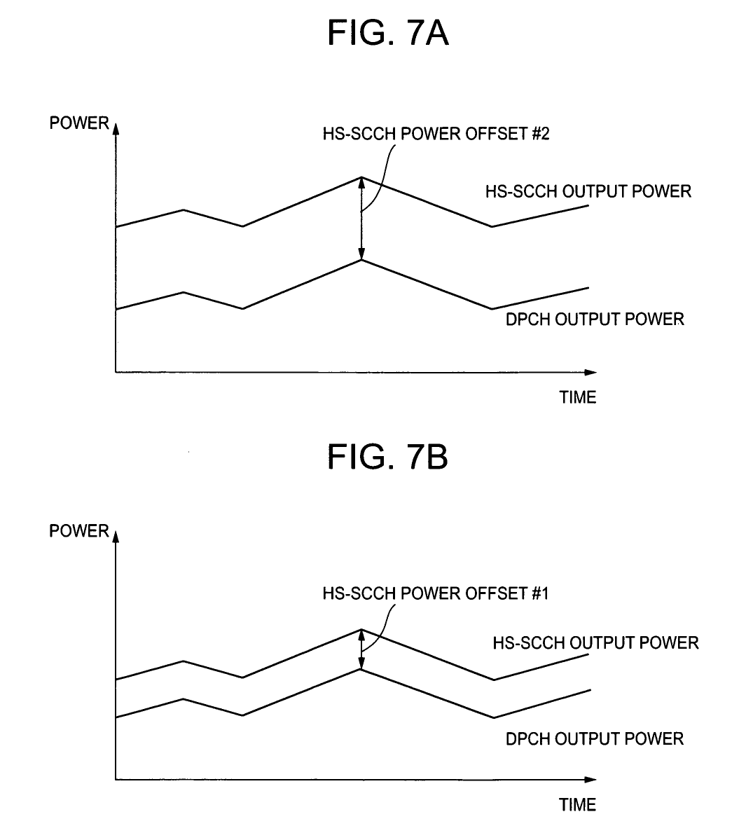

FIGS. 7A and 7B show states of power control on the HS-SCCH. FIG. 7A shows the state of power control in a handover state and FIG. 7B, that in a non-handover state.

As shown in FIG. 7A, in the handover state, the transmission power of the HS-SCCH is the sum of addition of the HS-SCCH power offset #2 to the DPCH downlink-transmission power. On the other hand in the non-handover state as shown in FIG. 7B, the transmission power of the HS-SCCH is the sum of addition of the HS-SCCH power offset #1 to the DPCH downlink-transmission power.

As hitherto described, this embodiment of the invention can individually set for the handover state and the non-handover state power offset values from individual channels incidental to the HS-SCCH. Therefore, the transmission power of the HS-SCCH can be kept optimal for the UE 14 in the handover state, making it possible to improve the quality of HSDPA communication, more specifically to improve the throughput by reducing re-transmission and other undesirable factors.

Further, as selection is made out of HS-SCCH power offsets adaptable to the pertinent station, which are held by the Node B #1 12, the HS-SCCH transmission power fitting the Node B #1 12 can be set appropriately and flexibly.

Next, a mobile communication system pertaining to another preferred embodiment of the invention will be described.

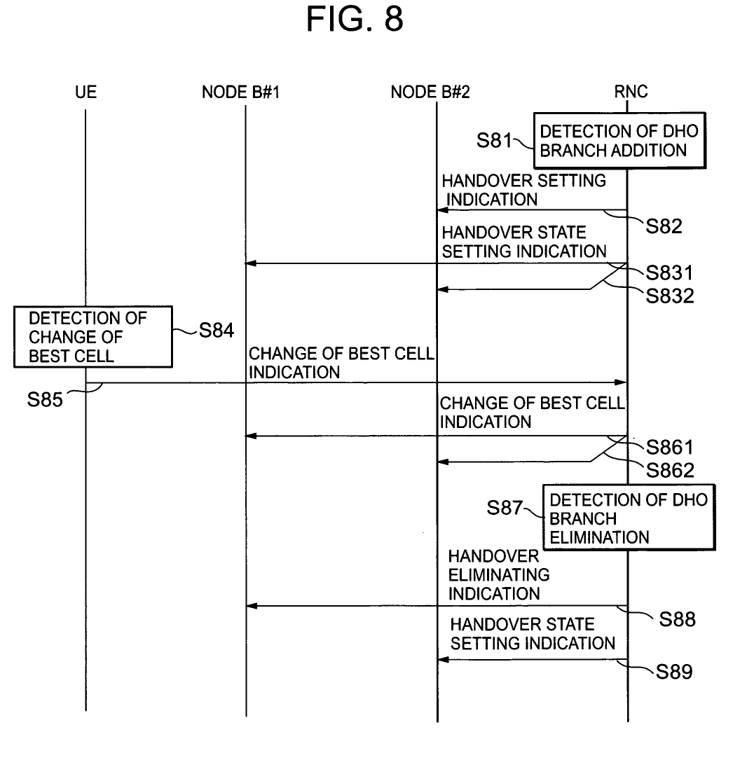

FIG. 8 is a sequence chart of the operation of a mobile communication system, which is another embodiment of the invention. More specifically, FIG. 8 shows how the RNC 11, the Node B #1 12, the Node B #2 13 and the UE 14 operate when the UE 14 performing HSDPA communication is to carry out a handover. Here, the UE 14 shifts from the cell area of the Node B #1 12 to the cell area of the Node B #2 13. The difference from the operation of the mobile communication system shown in FIG. 3 consists in the addition of steps S84 through S862, but the sequence is the same in all other respects. Therefore, the following description will mainly focus on the steps S84 through S862.

In the handover state, the transmission power on the downlink-DPCH is optimized with reference to the cell providing the optimal reception quality to the UE 14 (hereinafter referred to as the best cell). In the handover state, the UE 14 detects any change of the best cell from a cell in the Node B #1 12 to another in the Node B #2 13 as a result of the shift of the UE or some other cause (S84). Having detected the change of the best cell, the UE 14 delivers to the RNC 11 a “change of best cell indication” which notifies the change of the best cell (S85). As the change of best cell indication, the temporary identification (ID) which is used in the Site Selection Diversity Transmit Power Control (SSDT) system may be used. The temporary ID is individually assigned to each base station, and the UE 14 may notify the RNC 11 which cell is the best cell by sending the temporary ID. Then the RNC 11 notifies the change of best cell indication to the Node B #1 12 and the Node B #2 13 (S861 and S862). Until the RNC 11 detects a DHO branch elimination (S87), this action can be done. In this way, the Node B #1 12 and the Node B #2 13 can perceive whether or not their own stations are in a best cell state. Incidentally, the change of best cell indication can be notified by the Iub frame protocol.

As described above, the change of best cell is notified to the Node B #1 12 and Node B #2 13 by the RNC 11, but it can be notified directly to the Node B #1 12 and Node B #2 13 by the UE 14 by sending the temporary ID to them.

Next will be described the operation of another mobile communication system according to the invention, in particular the operation of the Node B #1 12.

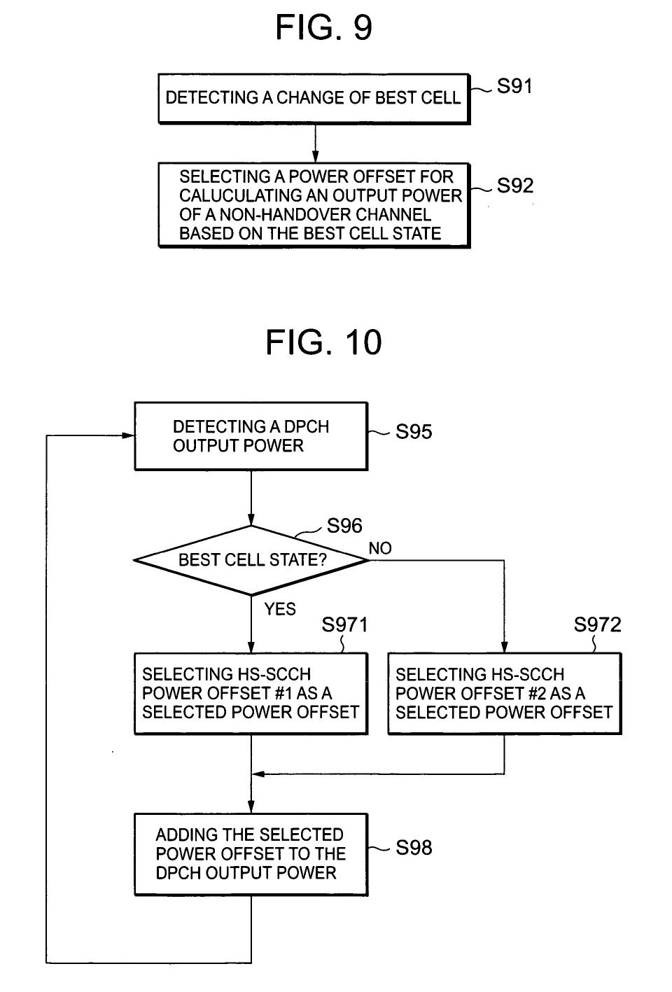

FIG. 9 is a flow chart for describing the operation by which the Node B #1 12 calculates the transmission power of the HS-SCCH 103 in the mobile communication system performing HSDPA communication.

First, the Node B #1 12 detects the best cell state (S91) At this step, the Node B #1 12 detects whether or not its own state is in the best cell state. This step can be accomplished having the Iub frame protocol processor 22 shown in FIG. 2 process the information regarding the presence or absence of the best cell state, which the RNC 11 notifies by using the Iub frame protocol 40.

Next, the Node B #1 12 selects a power offset for calculating the transmission power of the non-handover channel on the basis of the detected information regarding the best cell state (S92). The non-handover channel here means the HS-SCCH 103. This step can be accomplished by, for instance, the HS-SCCH transmission power calculator 20 shown in FIG. 2. This operation will be described afterwards.

The operation so far described provides the following benefits. Thus, since the HS-SCCH transmission power is determined on the basis of whether or not the Node B #1 12 is in the best cell state, it is possible to keep the HS-SCCH transmission power at an appropriate level for the UE 14 according to whether or not it is in the best cell state. As a result, the quality of the HSDPA communication can be improved.

Next, the operation of the Node B #1 12 will be described in more specific terms.

FIG. 10 is a flow chart for describing the operation at S92 in FIG. 9 in more specific terms.

First, the Node B #1 12 recognizes the DPCH downlink-transmission power (S95). Recognition of the DPCH downlink-transmission power can be accomplished by the DPCH signal processor 21 shown in FIG. 2. The DPCH signal processor 21 notifies the adder 26 of the DPCH downlink-transmission power information 201.

The Iub frame protocol processor 22 instructs the selection circuit 25 to select either the HS-SCCH power offset #1 or #2 on the basis of the information regarding the presence or absence of the best cell state detected at S91 in FIG. 9 (S96). The HS-SCCH power offset #1 and #2 are set in advance by the RNC 11 or some other maintenance means with respect to the Node B #1 12, and respectively stored in the HS-SCCH power offset #1 memory 23 and the HS-SCCH power offset #2 memory 24. Or the control device of the Node B #1 12 may determine an HS-SCCH power offset value according to the state of the electric wave or some other factor, and store it in the memory. Further, the control device of the Node B #1 12 may as well control the HS-SCCH power offset in a timely manner to be adaptable to its own station, and store it in the memory. It is more preferable for the HS-SCCH power offset #2 to be greater than the HS-SCCH power offset #1. In this case, it is intended to improve the quality of communication by increasing the transmission power in any other state than the best cell state.

If the presence of the best cell state is detected, the Iub frame protocol processor 22 instructs the selection circuit 25 to select the HS-SCCH power offset #1. In response, the selection circuit 25 selects the HS-SCCH power offset #1 (S971).

If the absence of the best cell state is detected, the Iub frame protocol processor 22 instructs the selection circuit 25 to select the HS-SCCH power offset #2. In response, the selection circuit 25 selects the HS-SCCH power offset #2 (S972).

The selection circuit 25 notifies the adder 26 of either the HS-SCCH power offset #1 or the HS-SCCH power offset #2 selected at S971 or S972, respectively, as the HS-SCCH power offset information 202.

The adder 26 adds the DPCH downlink-transmission power notified by the DPCH signal processor 21 to the selected HS-SCCH power offset, which has been notified by the selection circuit 25 (S98).

The HS-SCCH transmission power calculated in this way is notified to an HS-SCCH transmission power control device (not shown). The operation described above is repeated for each slot of the HS-SCCH.

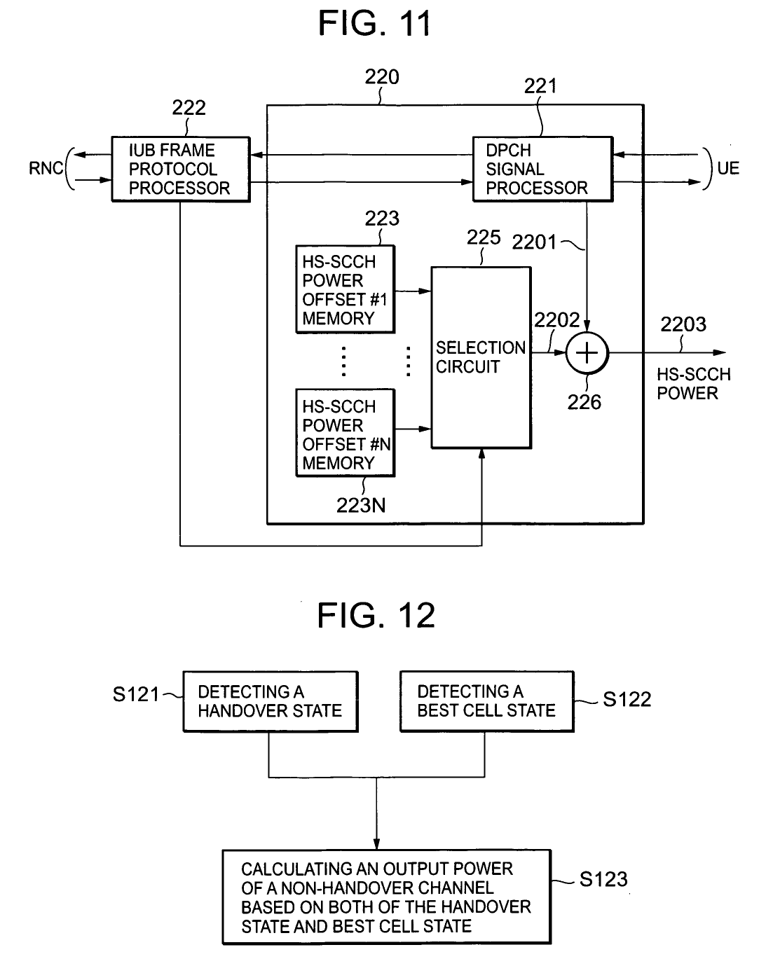

FIG. 11 is a block diagram showing the configuration of an HS-SCCH transmission power determining unit pertaining to another embodiment of the invention in the Node B #1 12 and the Node B #2 13 of FIG. 1. It differs from FIG. 2 in that it is provided with N (N≧3) HS-SCCH power offset memories. Thus, N is not limited to 2, but may be 3 or more. Incidentally, an HS-SCCH power offset #1 memory 223 through an HS-SCCH power offset #N memory 223N are not confined to this form, but the HS-SCCH power offsets #1 through #N may as well be held in a physically single memory. This configuration enables an HS-SCCH power offset to be selected to match a state in which the UE 14 or the Node B #1 12 and the Node B #2 13 are divided into finer segments.

FIG. 12 is a flow chart for describing the operation of the Node B #1 12 to calculate the transmission power of the HS-SCCH 103 in a mobile communication system performing HSDPA communication pertaining to another preferred embodiment of the invention.

First, the Node B #1 12 detects a handover state (S121) At this step, the Node B #1 12 detects whether or not the UE 14 is in a handover state. This step can be accomplished by having an Iub frame protocol processor 222 shown in FIG. 11 process information regarding the presence or absence of a handover state notified by the RNC 11 using the Iub frame protocol 40. Reception of the Iub protocol from the RNC 11 by the Node B #1 12 makes possible high-speed detection of information regarding the handover state.

In addition to S121, the Node B #1 12 detects the best cell state (S122). At this step, the Node B #1 12 detects whether or not its own station is in the best cell state. This step, too, can be accomplished by having the Iub frame protocol processor 222 shown in FIG. 11 process information regarding the presence or absence of the best cell state notified by the RNC 11 using the Iub frame protocol 40.

Next, the Node B #1 12 calculates the transmission power of the non-handover channel on the basis of information on the detected handover state and the best cell state (S123) The non-handover channel means the HS-SCCH 103. This step can be accomplished by, for instance, an HS-SCCH transmission power calculator 220 shown in FIG. 11. This operation will be described afterwards.

The operation so far described provides the following benefits. Thus, since the HS-SCCH transmission power is determined on the basis of whether or not the Node B #1 12 is in a handover state, it is possible to keep the HS-SCCH transmission power at an appropriate level for the UE 14 according to whether or not its own station is in a handover state and whether or not it is in the best cell state. As a result, the quality of the HSDPA communication can be improved.

Next, the operation at S123 in FIG. 12 will be described in more specific terms.

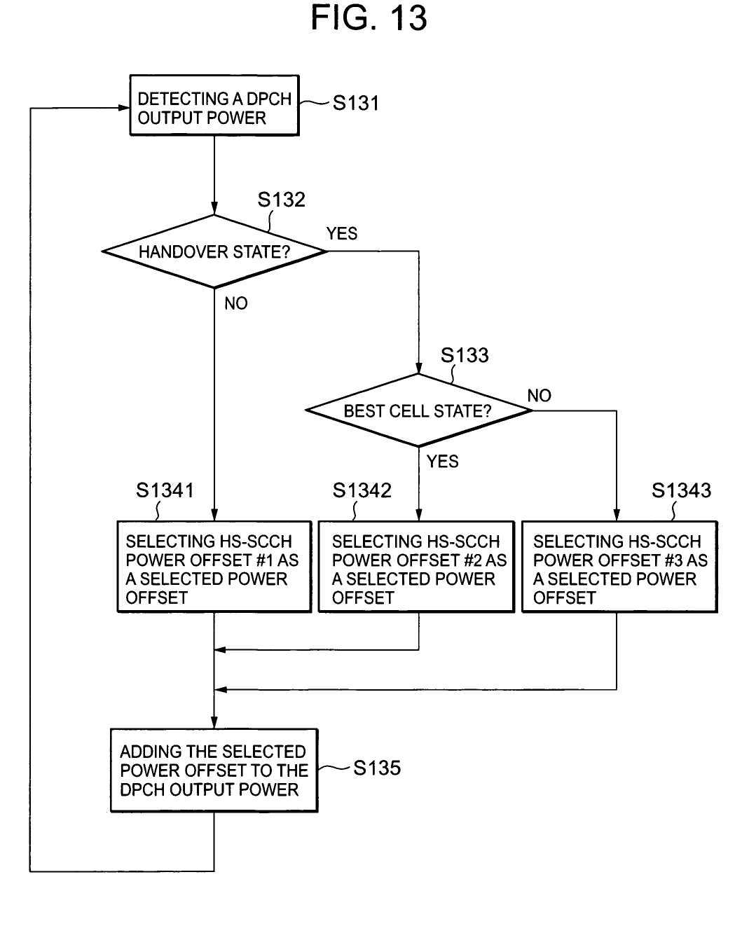

FIG. 13 is a flow chart for describing the operation at S123 in FIG. 12 in more specific terms.

This embodiment can have, with reference to FIG. 11, three HS-SCCH power offset memories (N=3), including an HS-SCCH power offset #1 223, an HS-SCCH power offset #2 2232 and an HS-SCCH power offset #3 2233.

First, the Node B #1 12 recognizes the DPCH downlink-transmission power (S131). The recognition of the DPCH downlink-transmission power can be accomplished by a DPCH signal processor 221 shown in FIG. 11. The DPCH signal processor 221 notifies an adder 226 of DPCH downlink-transmission power information 2201.

In this embodiment, the Iub frame protocol processor 222 instructs a selection circuit 225 to select one out of the HS-SCCH power offsets #1, #2 and #3 on the basis of information regarding the presence or absence of a handover state detected at S121 in FIG. 12 and information regarding the presence or absence of the best cell state detected at S122 (S132 and S133). The HS-SCCH power offsets #1, #2 and #3 are set in advance by the RNC 11 or some other maintenance means with respect to the Node B #1 12, and respectively stored in the HS-SCCH power offset #1 memory 223, the HS-SCCH power offset #2 memory 2232, the HS-SCCH power offset #3 memory 2233. Or the control device of the Node B #1 12 may determine an HS-SCCH power offset value according to the state of the electric wave or some other factor, and store it in the memory. Further, the control device of the Node B #1 12 may as well control the HS-SCCH power offset in a timely manner to be adaptable to its own station, and store it in the memory. It is more preferable for the HS-SCCH power offset #3 to be greater than the HS-SCCH power offset #2 and the HS-SCCH power offset #2 to be greater than the HS-SCCH power offset #1. In this case, it is intended to improve the quality of communication by increasing the transmission power in the handover state and increasing the transmission power in any other state than the best cell state.

If the absence of a handover state is detected, the Iub frame protocol processor 222 will instruct the selection circuit 225 to select the HS-SCCH power offset #1. In response, the selection circuit 225 selects the HS-SCCH power offset #1 (S1341).

If the presence of both a handover state and the best cell state is detected, the Iub frame protocol processor 222 will instruct the selection circuit 225 to select the HS-SCCH power offset #2. In response, the selection circuit 225 selects the HS-SCCH power offset #2 (S1342).

If the presence of a handover state and the absence of the best cell state are detected, the Iub frame protocol processor 222 will instruct the selection circuit 225 to select the HS-SCCH power offset #3. In response, the selection circuit 225 selects HS-SCCH power offset #3 (S1343).

The selection circuit 225 notifies the adder 226 of one of the HS-SCCH,power offset #1 through the HS-SCCH power offset #3 selected at S1341 through S1343, respectively, as the selected HS-SCCH power offset information 2202.

The adder 226 adds the DPCH downlink-transmission power notified by the DPCH signal processor 221 to the selected HS-SCCH power offset, which has been notified by the selection circuit 225 (S135).

The HS-SCCH transmission power thereby calculated is notified to an HS-SCCH transmission power the control device (not shown). The operation described above is repeated for each slot of the HS-SCCH.

Incidentally in the operation described above, the use of the Iub frame protocol is not absolutely necessary for the handover state setting indication set by the RNC 11 for the Node B #1 12 and the Node B #2 13. Some other protocol, for instance a layer 3 protocol between the RNC 11 and the Node B #1 12 or the Node B #2 13, may as well be used.

Further, the use of the present invention is not confined to the transmission power control system for the control channel in an HSDPA communication system. In a communication system simultaneously using a channel on which a diversity handover is performed and a channel on which no diversity handover is performed, the invention can be generally applied to transmission power control on the channel on which no diversity handover is performed.

Although the invention has been described with respect to handovers between two cells, its use is not restricted to such handovers, but can also be applied to handovers among three or more cells.

1. A mobile communication system which uses a plurality of channels for communication, the plurality of channels comprising:
a first channel on which a mobile terminal communicates simultaneously with both a first base station and a second base station in a handover state wherein the mobile terminal is in an overlapping area of a cell of the first base station and a cell of the second base station; and
a second channel on which the mobile terminal communicates with one of the first and second base stations even in the handover state, wherein
the one of the first and second base stations comprises:
a handover state detector for detecting information notified by a radio network controller regarding whether or not the mobile terminal is in the handover state; and
a transmission power calculator for calculating a value of downlink transmission power on the second channel on the basis of the information detected by the handover state detector.

2. The mobile communication system according to claim 1, wherein the transmission power calculator comprises means for adding a specified offset value to a value of reference transmission power for calculating a value of downlink transmission power on the second channel if said information indicates that the mobile is in the handover state.

3. The mobile communication system according to claim 1, wherein the transmission power calculator comprises:
one or a plurality of memories for storing a plurality of different power offsets; and
a selector for selecting one power offset out of the plurality of different power offsets stored in the one or plurality of memories on the basis of the information detected by the handover state detector.

4. The mobile communication system according to claim 1, wherein the transmission power calculator comprises:
a signal processor for supplying a value of transmission power on the first channel;
a memory for storing a first power offset and a second power offset;
a selector for selecting the first power offset if the handover state detector does not detect that the mobile terminal is in the handover state, and selecting the second power offset if the handover state detector detects that the mobile terminal is in the handover state; and
an adder for adding a value of one of the first and second power offsets selected by the selector to the value of transmission power on the first channel supplied by the signal processor.,

5. The mobile communication system according to claim 1, which performs communication between the mobile terminal and the first and/or second base stations by an HSDPA (High Speed Downlink Packet Access) communication system wherein the first channel is a DPCH (Dedicated Physical Channel) and the second channel is an HS-SCCH [Shared Control CHannel for HS-DSCH (High Speed Downlink Shared CHannel)].

6. A mobile communication system which uses a plurality of channels for communication, the plurality of channels comprising:
a first channel on which a mobile terminal communicates simultaneously with both a first base station and a second base station in a handover state wherein the mobile terminal is in an overlapping area of a cell of the first base station and a cell of the second base station; and
a second channel on which the mobile terminal communicates with one of the first and second base stations even in the handover state, wherein
the one of the first and second base stations comprises:
a best cell state detector for detecting information notified by a radio network controller regarding whether or not the cell of the one of the first and second base stations is in a best cell state; and
a selector for selecting a power offset on the basis of the information detected by the best cell state detector for calculating a value of downlink transmission power on the second channel.

7. The mobile communication system according to claim 6, wherein the transmission power calculator comprises:
a signal processor for supplying a value of transmission power on the first channel;
a memory for storing a first power offset and a second power offset;
a selector for selecting the first power offset if the best cell state detector detects that the cell of the one of the first and second base stations is in the best cell state, and selecting the second power offset if the best cell state detector does not detect that the cell of the one of the first and second base stations is in the best cell state; and
an adder for adding a value of one of the first and second power offset selected by the selector to the value of transmission power on the first channel supplied by the signal processor.

8. A mobile communication system which uses a plurality of channels for communication, the plurality of channels comprising:
a first channel on which a mobile terminal communicates simultaneously with both a first base station and a second base station in a handover state wherein the mobile terminal is in an overlapping area of a cell of the first base station and a cell of the second base station; and
a second channel on which the mobile terminal communicates with one of the first and second base stations even in the handover state, wherein
the one of the first and second base stations comprises:
a handover state detector for detecting information notified by a radio network controller regarding whether or not the mobile terminal is in the handover state;
a best cell state detector for detecting information notified by a radio network controller regarding whether or not the cell of the one of the first and second base stations is in a best cell state; and
a transmission power calculator for calculating a value of downlink transmission power on the second channel on the basis of both the information detected by the handover state detector and the information detected by the best cell state detector.

9. The mobile communication system according to claim 8, wherein the transmission power calculator comprises:
a signal processor for supplying a value of transmission power on the first channel;
a memory for storing a first power offset, a second power offset and a third power offset;
a selector for selecting the first power offset if the handover state detector does not detect that the mobile terminal is in the handover state, selecting the second power offset if the handover state detector detects that the mobile terminal is in the handover state and moreover the best cell state detector detects that the cell of the one of the first and second base stations is in the best cell state, and selecting the third power offset if the handover state detector detects that the mobile terminal is in the handover state and moreover the best cell state detector does not detect that the cell of the one of the first and second base stations is in the best cell state;
an adder for adding a value of one of the first, second and third power offsets selected by the selector to the value of transmission power on the first channel supplied by the signal processor.

10. A base station which uses a plurality of channels for communication, the plurality of channels comprising:
a first channel on which a mobile terminal communicates simultaneously with both said base station and a second base station in a handover state wherein the mobile terminal is in an overlapping area of a cell of said base station and a cell of the second base station; and
a second channel on which the mobile terminal communicates with said base station even in the handover state,
said base station comprising:
a handover state detector for detecting information notified by a radio network controller regarding whether or not the mobile terminal is in the handover state; and
a transmission power calculator for calculating a value of downlink transmission power on the second channel on the basis of the information detected by the handover state detector.

11. The base station according to claim 10, wherein the transmission power calculator comprises:
one or a plurality of memories for storing a plurality of different power offsets; and
a selector for selecting one power offset out of the plurality of different power offsets stored in the one or plurality of memories on the basis of the information detected by the handover state detector.

12. The base station according to claim 10, wherein the transmission power calculator comprises:
a signal processor for supplying a value of transmission power on the first channel;
a memory for storing a first power offset and a second power offset;
a selector for selecting the first power offset if the handover state detector does not detect that the mobile terminal is in the handover state, and selecting the second power offset if the handover state detector detects that the mobile terminal is in the handover state; and
an adder for adding a value of one of the first and second power offsets selected by the selector to the value of transmission power on the first channel supplied by the signal processor.

13. The base station according to claim 10, wherein the base station communicates with the mobile terminal in an HSDPA communication system, and the first channel is a DPCH, and the second channel is an HS-SCCH.

14. A base station which uses a plurality of channels for communication, the plurality of channels comprising:
a first channel on which a mobile terminal communicates simultaneously with both said base station and a second base station in a handover state wherein the mobile terminal is in an overlapping area of a cell of said base station and a cell of the second base station; and
a second channel on which the mobile terminal communicates with said base station even in the handover state,
said base station comprising:
a best cell state detector for detecting information notified by a radio network controller regarding whether or not the cell of said base station is in a best cell state; and
a selector for selecting a power offset on the basis of the information detected by the best cell state detector for calculating a value of downlink transmission power on the second channel.

15. The base station according to claim 14, wherein the transmission power calculator comprises:
a signal processor for supplying a value of transmission power on the first channel;
a memory for storing a first power offset and a second power offset;
a selector for selecting the first power offset if the best cell state detector detects that the cell of said base station is in the best cell state, and selecting the second power offset if the best cell state detector does not detect that the cell of said base station is in the best cell state; and
an adder for adding a value of one of the first and second power offset selected by the selector to the value of transmission power on the first channel supplied by the signal processor.

16. A base station which uses a plurality of channels for communication, the plurality of channels comprising:
a first channel on which a mobile terminal communicates simultaneously with both said base station and a second base station in a handover state wherein the mobile terminal is in an overlapping area of a cell of said base station and a cell of the second base station; and
a second channel on which the mobile terminal communicates with said base station even in the handover state,
said base station comprising:
a handover state detector for detecting information notified by a radio network controller regarding whether or not the mobile terminal is in a handover state;
a best cell state detector for detecting information notified by a radio network controller regarding whether or not the cell of said base station is in a best cell state; and
a transmission power calculator for calculating a value of downlink transmission power on the second channel on the basis of both the information detected by the handover state detector and the information detected by the best cell state detector.

17. The base station according to claim 16, wherein the transmission power calculator comprises:
a signal processor for supplying a value of transmission power on the first channel;
a memory for storing a first power offset, a second power offset and a third power offset;
a selector for selecting the first power offset if the handover state,detector does not detect that the mobile terminal is in the handover state, selecting the second power offset if the handover state detector detects that the mobile terminal is in the handover state and moreover the best cell state detector detects that the cell of said base station is in the best cell state, and selecting the third power offset if the handover state detector detects that the mobile terminal is in the handover state and moreover the best cell state detector does not detect that the cell of said base station is in the best cell state;
an adder for adding a value of one of the first, second and third power offsets selected by the selector to the value of transmission power on the first channel supplied by the signal processor.

18. A transmission power control method for mobile communication systems which uses a plurality of channels for communication, the plurality of channels comprising:
a first channel on which a mobile terminal communicates simultaneously with both a first base station and a second base station in a handover state wherein the mobile terminal is in an overlapping area of a cell of the first base station and a cell of the second base station; and
a second channel on which the mobile terminal communicates with one of the first and second base stations even in the handover state,
the method comprising:
at the one of the first and second base stations,
detecting information notified by a radio network controller regarding whether or not the mobile terminal is in the handover state; and
calculating a value of downlink transmission power on the second channel on the basis of said information.

19. The transmission power control method for mobile communication systems according to claim 18, further comprising, at the one of the first and second base stations, selecting an offset value out of a plurality of different power offset values stored in the one of the first and second base stations on the basis of said information.

20. The transmission power control method for mobile communication systems according to claim 18, further comprising:
at the one of the first and second base stations,
supplying a value of transmission power on the first channel;
selecting a first power offset if said information indicates that the mobile terminal is not in the handover state;
selecting a second power offset if said information indicates that the mobile terminal is in the handover state; and
adding the selected first or second power offset to the value of transmission power on the first channel.

21. The transmission power control method for mobile communication systems according to claim 18, wherein the method is used for communication between the mobile terminal and the first and/or second base stations in an HSDPA communication system, and the first channel is a DPCH, and the second channel is an HS-SCCH.

22. A transmission power control method for mobile communication systems which uses a plurality of channels for communication, the plurality of channels comprising:
a first channel on which a mobile terminal communicates simultaneously with both a first base station and a second base station in a handover state wherein the mobile terminal is in an overlapping area of a cell of the first base station and a cell of the second base station; and
a second channel on which the mobile terminal communicates with one of the first and second base stations even in the handover state,
the method comprising:
at the one of the first and second base stations,
detecting information notified by a radio network controller regarding whether or not the cell of the one of the first and second base stations is in a best cell state;
selecting a power offset on the basis of said information; and
calculating a downlink transmission power on the second channel on the basis of the power offset.

23. The transmission power control method for mobile communication systems according to claim 22, further comprising:
at the one of the first and second base stations,
supplying a value of transmission power on the first channel;
selecting a first power offset if said information indicates that the cell of the one of the first and second base stations is in the best cell state;
selecting a second power offset if said information indicates that the cell of the one of the first and second base stations is not in the best cell state; and
adding the selected first or second power offset to the value of transmission power on the first channel.

24. A transmission power control method for mobile communication systems which uses a plurality of channels for communication, the plurality of channels comprising:
a first channel on which a mobile terminal communicates simultaneously with both a first base station and a second base station in a handover state wherein the mobile terminal is in an overlapping area of a cell of the first base station and a cell of the second base station; and
a second channel on which the mobile terminal communicates with one of the first and second base stations even in the handover state,
the method comprising:
at the one of the first and second base stations,
detecting first information notified by a radio network controller regarding whether or not the mobile terminal is in the handover state;
detecting second information notified by a radio network controller regarding whether or not the one of the first and second base stations is in a best cell state; and
calculating a value of downlink transmission power of the second channel on the basis of both the first and second information.

25. The transmission power control method for mobile communication systems according to claim 24, further comprising:
at the one of the first and second base stations,
supplying a value of transmission power on the first channel;
selecting a first power offset if the first information indicates that the mobile terminal is not in the handover state;
selecting a second power offset if the first information indicates that the mobile terminal is in the handover state and moreover the second information indicates that the cell of the one of the first and second base stations is in the best cell state;
selecting a third power offset if the first information indicates that the mobile terminal is in the handover state and moreover the second information indicates that the cell of the one of the first and second base stations is not in the best cell state; and
adding the selected one of the first, second and third power offsets to the value of transmission power on the first channel.
